(19) United States
(12) Patent Application Publication
(10) Pub. No.: US 2019/0054369 A1
(43) Pub. Date: Feb. 21, 2019

(54) THREE-DIMENSIONAL CHARACTER DICE, GAME, AND METHOD OF MAKING

(71) Applicant: Brian Kelly Edwards, Erie, PA (US)

(72) Inventor: Brian Kelly Edwards, Erie, PA (US)

(21) Appl. No.: 15/679,540

(22) Filed: Aug. 17, 2017

(51) Int. Cl. A63F 9/04; A63F 1/04; B29C 64/10; B33Y 10/00; B33Y 80/00; B29C 33/38; B29C 64/393

(52) U.S. Cl. CPC A63F 9/0415; A63F 1/04; B29C 64/10; B33Y 10/00; B33Y 80/00; B29L 2031/7722; B29C 64/393; A63F 2009/0484; A63F 2009/0497; A63F 2001/0441; B29C 33/3842

(57) ABSTRACT

Two games, “Sugar Rush” and “Candy Grab” are disclosed using 3D character dice and a deck of candy cards. The dice can take one of many forms and may have any even number of sides from 4 to 20 and may develop into a collectible set of characters. These boardless games can be learned easily and enjoyed by all. A product by process is also disclosed.

This patent application is a continuation-in-part of U.S. patent application Ser. No. 14/733,802 which claims priority benefit of provisional pat. appl. Ser. No. 62/069,185 filed Oct. 27, 2014, both of which are hereby incorporated by reference.

### BACKGROUND AND SUMMARY OF THE INVENTION

The present invention is directed to the field of amusement devices. More particularly, the present invention is directed to games played with three-dimensional dice.

Typical board games utilize conventional hexahedral dice having pips, numbers, or icons on the side. In some such games, miniature characters are utilized as game pieces, in addition to the dice. While, generally, board games have given way to electronic games due to the ease of transport and the wide variety of games available, for the most part, the electronic games take the camaraderie and one-on-one (or one vs several) competition off the table, as most electronic games tend to be man/woman against machine.

It is among the purposes of this invention to provide a simplified game which requires no board to play allowing it to be readily carried in a compact case designed therefor, thereby reinstating the personal touch to competition. In addition, these dice can depict exotic characters and, thus, become collectibles, as well as game-functioning dice. The particular designs suggested herein are exemplary of the types of characters which can be included and these designs readily lend themselves to this type of competition. Further, the three-dimensional character dice of the present invention may take any form desired and, with appropriate permission from copyright holders, may emulate famous/popular characters, real or imaginary. While typically people envision dice as having 6 sides, the dice of the present invention may have any even number from 4 to 20 sides without departing from the scope of the invention. Lastly, it is envisioned that these may be “transformer” dice, i.e., have hinged/removable parts which enhance characterization that are then folded/replaced back into the body for functioning as a die.

Traditionally, dice have taken the form of flat-sided cubes (hexahedrons) which have no real interest in themselves and, hence, can readily lead to disinterest in the game, particularly, should the dice not be rolling one's way. The three-dimensional character dice of the present invention maintain their interesting configuration with each side depicting a facet of the character and, as suggested previously, can be displayed as part of a collection when not “gamefully employed”.

Recent technological advances have made such dice more readily produced. The proposed methodology of manufacture would employ a 3D printer to formulate a model of the appropriate character shape. The model would then be utilized to form a reverse image mold and the end pieces then cast using a thermoplastic or thermoset resin.

The present invention is directed to a three-dimensional character die comprising a) a generally polygonally-shaped element, the polygonally-shaped element configured as a three-dimensional character for use as a die in a dice-rolling game, the three-dimensional character having a plurality ‘x’ of variously configured, non-planar sides; b) at least some of the plurality ‘x’ of variously configured, non-planar sides having maximum protruding extents lying in a plurality of ‘n’ different planes, wherein ‘n’>2. The value of ‘x’ is preferably in the range of between 4 and 20. Further, at least x−1 of said variously configured sides have completely unique configurations. It is also preferred that the number ‘n’ of different planes is ≥4. The dice of the present invention is preferably made by a process including the steps of a) forming a model using 3D printing; b) creating a fillable mold using said model; c) filling the fillable mold with a material to form the character die, the material being selected from a group consisting of thermoset resins and thermoplastic resins.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1A is a front perspective view of a first embodiment of the 3D character dice of the present invention configured as a fanciful mummy;

FIG. 1B is a front view of the embodiment shown in FIG. 1A;

FIG. 1C is a rear view of the first embodiment;

FIG. 1D is a bottom view of the first embodiment;

FIG. 1E is a view of the left side of the first embodiment;

FIG. 1F is a top view of the first embodiment;

FIG. 2 is a front perspective view of a second embodiment configured as a boogie man;

FIG. 3 is a front perspective view of a third embodiment configured as an alien;

FIG. 4 a front perspective view of a fourth embodiment configured as a yeti;

FIG. 5 is a front perspective view of a fifth embodiment configured as Frankenstein;

FIG. 5A is a first version of the front perspective view of Frankenstein;

FIG. 5B is a second version of Frankenstein juxtaposed with the FIG. 5A version to highlight the differences;

FIG. 6 is a front perspective view of a sixth embodiment configured as a ghost;

FIG. 7 is a front perspective view of a seventh embodiment configured as a vampire;

FIG. 8 is a front perspective view of a eighth embodiment configured as a werewolf;

FIG. 9A is a front perspective of one configuration of carrying case for the dice of the present invention with the top open;

FIG. 9B is a front perspective similar to FIG. 9A with the top closed;

FIG. 10A is a top view of a Cthulu, a character having four sides;

FIG. 10B is a front perspective view of the Cthulu of FIG. 10A;

FIG. 10C is a front view of the Cthulu;

FIG. 10D is a side view of the Cthulu;

FIG. 11A is a front perspective view of a block having ten sides;

FIG. 11B is a front perspective view of a demon hunter having ten sides;

FIG. 11C is a front view of the character shown in FIG. 11B;

FIG. 11D is a side view of the character depicted in FIG. 11B;

FIG. 12A is a three-quarter front perspective of a Cerberus having 12 sides;

FIG. 12B is front view of the character shown in FIG. 12A;

FIG. 12C is a top view of the character shown in FIG. 12A;

FIG. 12D is a bottom view of the character shown in FIG. 12A;

FIG. 12E is a rear view of the character shown in FIG. 12A;

FIG. 12F is a side view of the character shown in FIG. 12A;

FIG. 13A is a three-quarter view of a dragon having 20 sides;

FIG. 13B is a rear view of the character shown in FIG. 13A;

FIG. 13C bottom view of the character shown in FIG. 13A;

FIG. 13D is a front view of the character shown in FIG. 13A;

FIG. 13E is a side view of the character shown in FIG. 13A;

FIG. 13F is a top view of the character shown in FIG. 13A;

FIG. 14A is an example of a backup card; and,

FIG. 14B is an example of a character card.

### DETAILED DESCRIPTION OF THE PREFERRED EMBODIMENT(S)

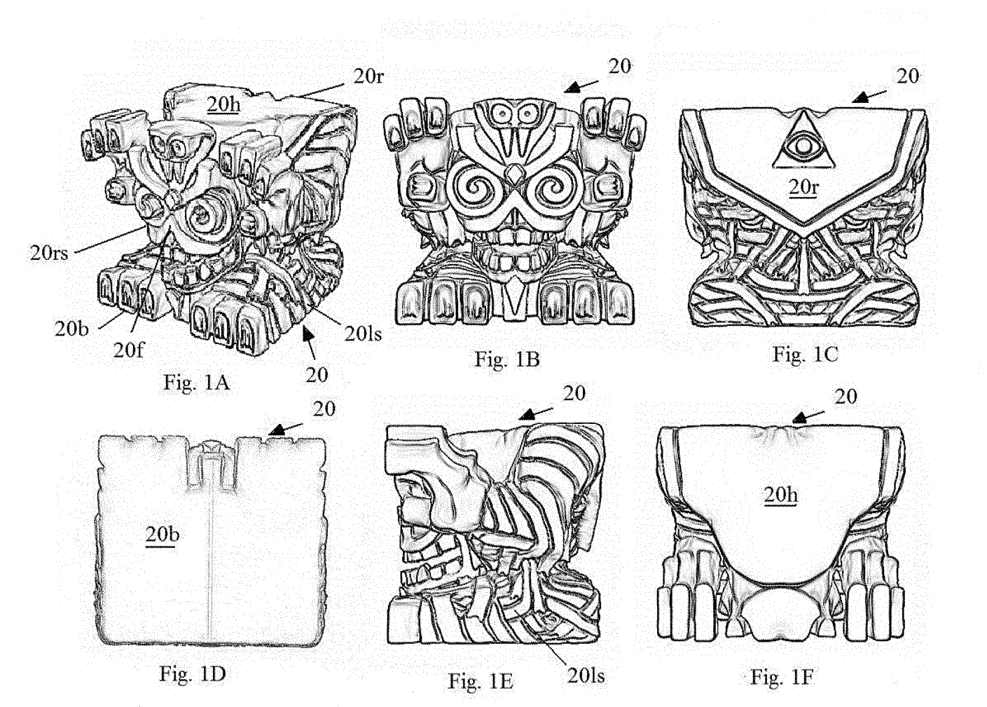

A first embodiment of the character die of the present invention is depicted in FIGS. 1A-1E generally at 20. In this first embodiment, the polygonal die is configured as a conventional hexahedron (six-sided) die embodied as a mummy. For this character, 20h is the head, 20b is the base, 20f is the face, 20r is the rear, 20rs is the right side and 20ls is the left side. Although shown larger to depict the details of the various profiles, the die 20 will typically be on the order of a 1″ cube (or alternate shape). Unlike conventional six-sided dice, the character die of the present invention has non-planar sides with ‘n’ lateral (or vertical) extents (variations in projection from a base level), with n being >2. More preferably, for at least some of the plurality of ‘x’ sides, the number of lateral extents exceeds 4. It will be appreciated that while the conventional hexahedron shape of die is shown, it is within the scope of the present invention for the number of sides to be any even number in the range of between 4 and 20. When a particular side of the die is rolled to the face-up position, it will control the type of move/provision provided on that roll.

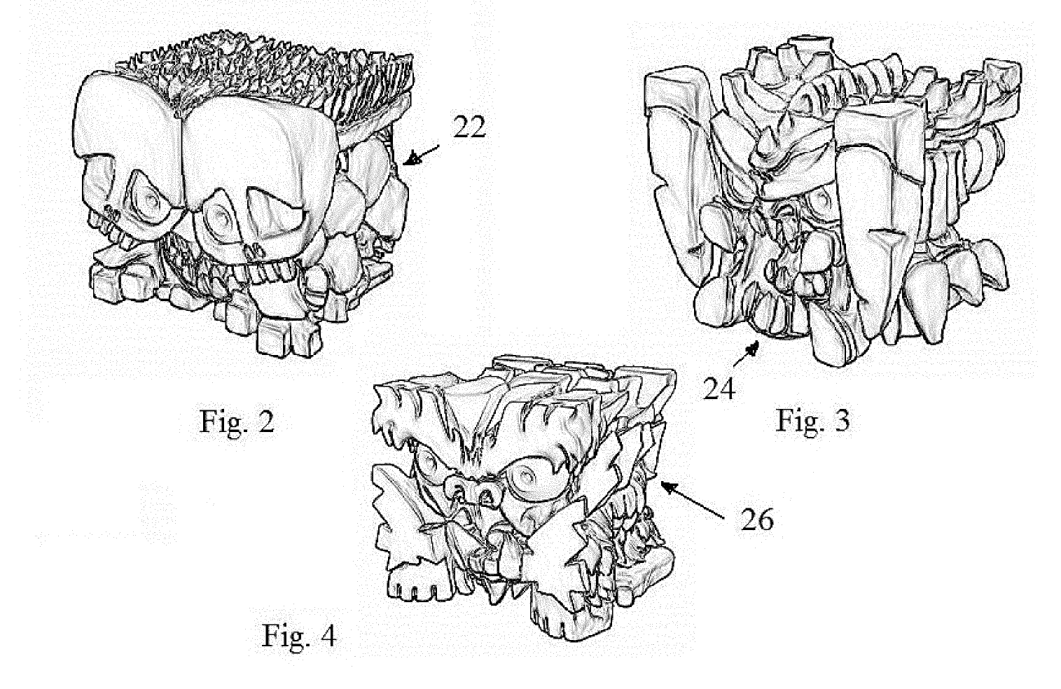

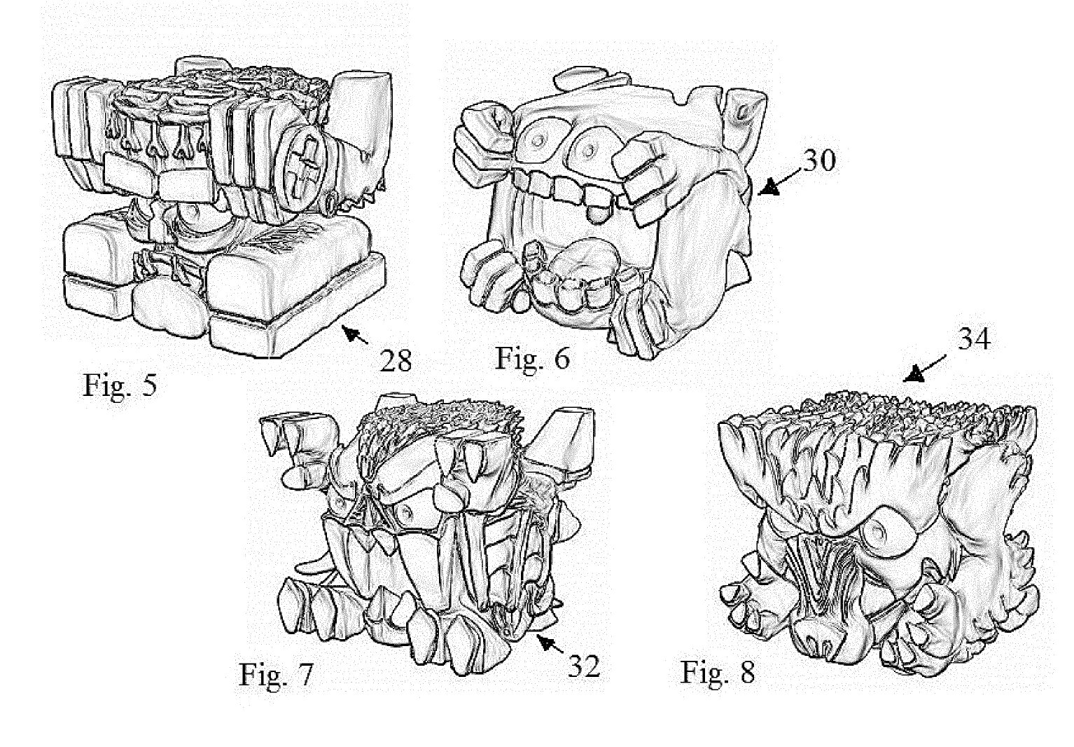

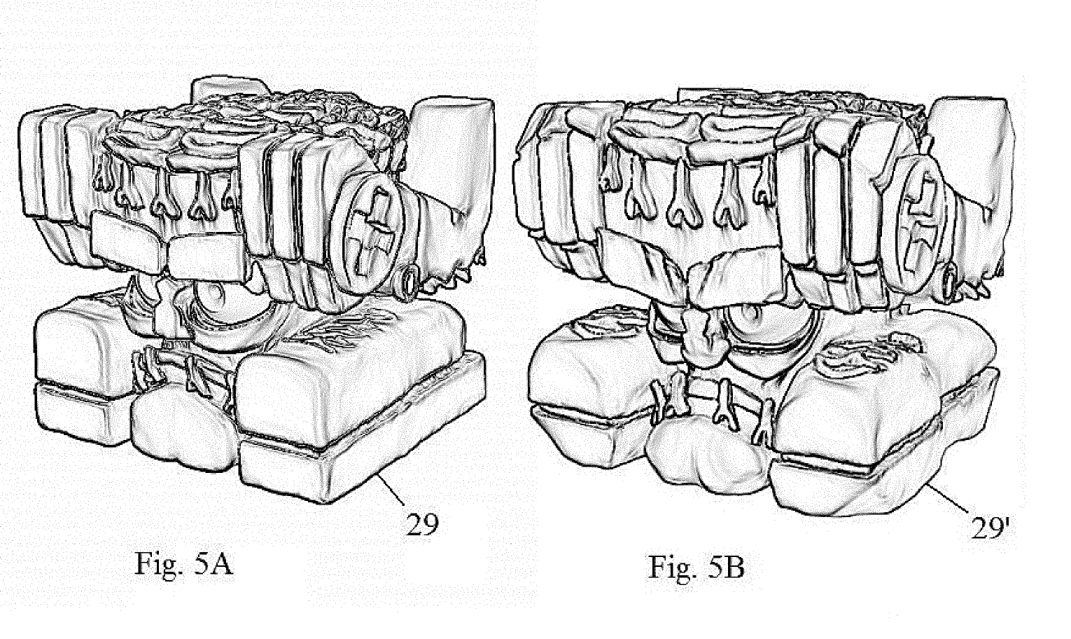

As has been noted, the character die of the present invention may be configured to represent any character desired. To substantiate that allegation, FIG. 2 depicts a boogie man at 22; FIG. 3, an alien at 24; FIG. 4, a yeti at 26; FIG. 5, Frankenstein at 28; FIG. 6, a ghost at 30; FIG. 7, a vampire at 32; and FIG. 8, a werewolf at 34. These figures are exemplary of the types of characters which are envisioned in conjunction with the present invention. Formerly, creating such shapes would require expensive carving techniques that would render creating such characters cost prohibitive for all but the well-to-do collectors. With the advent of 3D printing technology, a model can be formed, used to make a negative cavity mold and then, mass produced by filling the mold with a thermoset, or thermoplastic resins to include various elastomers, natural and man-made rubbers. In addition, it is envisioned that an iridescent pigment or other coloration could be added to the moldable material to make it glow in the dark. Further, it is within the scope of the invention to paint the die once it is formed to highlight the 3D features.

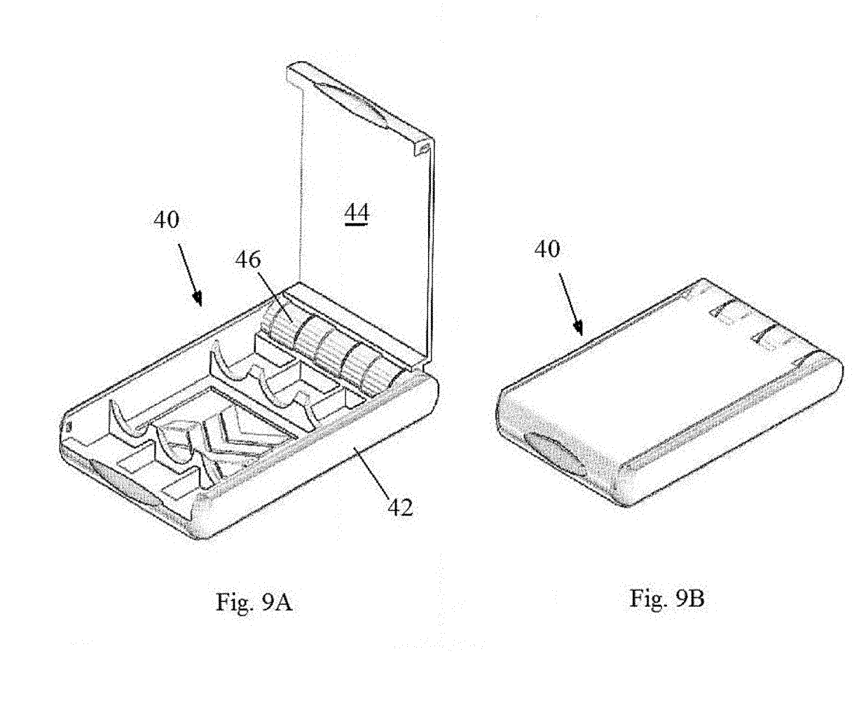

FIGS. 9A and 9B depict a carrying case 40 which permits several sets of character dice of the present invention to be easily transported. Carrying case 40 is comprised of a bottom with several chambers for receiving individual dice. Cover 44 is connected to base 42 by hinge 46. It will be appreciated that the depiction of carrying case 40 is simply exemplary. Configuration changes may be implemented to reduce plastic utilized in the construction by shrinking the size of the members from base 42 and cover 44 in hinge 46 and using a simple through rod as the actual hinge element.

Other variations are possible with regard to any of the characters. For example, it is envisioned that completely square edges will tend to make the dice slide on the playing surface, whereas, rounded corners will facilitate the rolling motion desired for game dice. As shown in FIGS. 5A and 5B, the edges 29 of the Frankenstein character 28 may be rounded as at 29′ in FIG. 5B. As can be seen by comparing these two figures, this rounding has a tendency to “soften” the features of the character. It will be appreciated that this adaptation may be applied to any of the characters shown or others which may be envisioned.

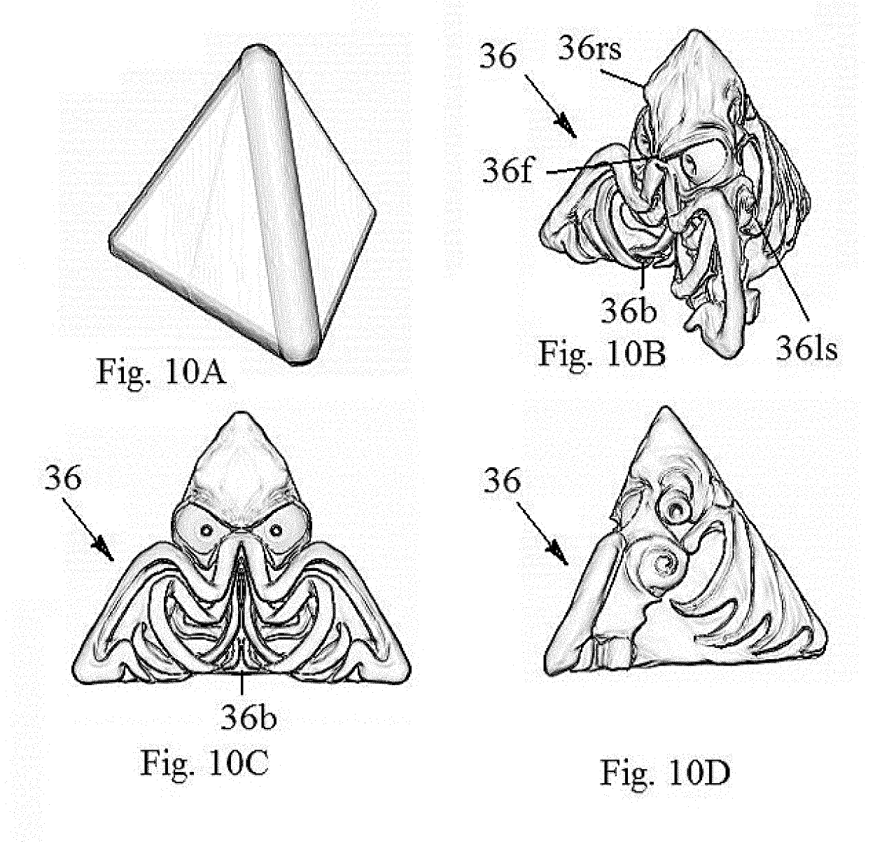

In addition to the traditional hexahedronally shaped dice, the 3-D character dice of the present invention may have any even number of sides between 4 and 20. The Cthulu depicted in FIGS. 10A-10D comprise a four-sided character dice 36 having left side 36ls, right side 36rs, front face 36f, and bottom 36b.

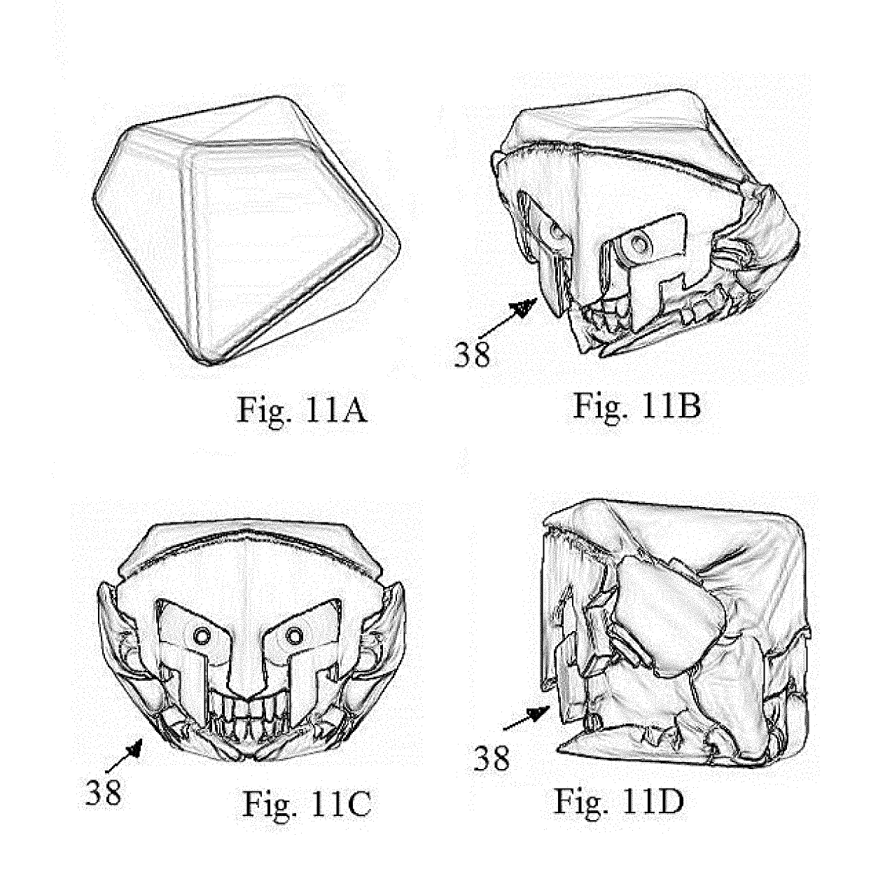

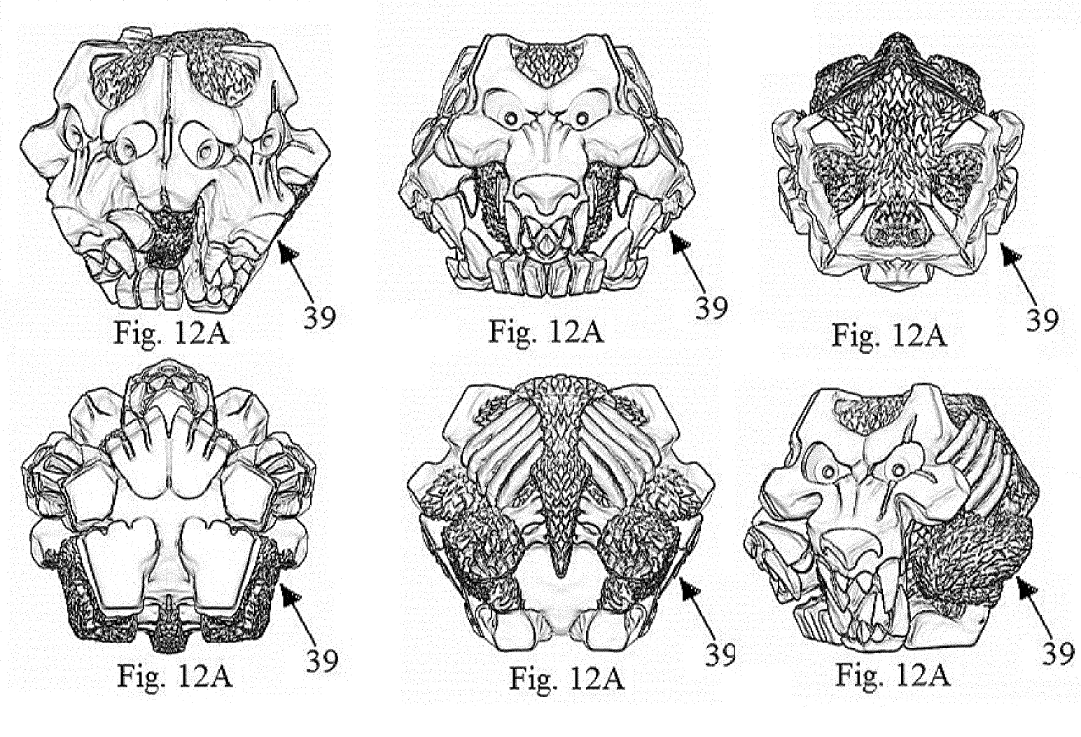

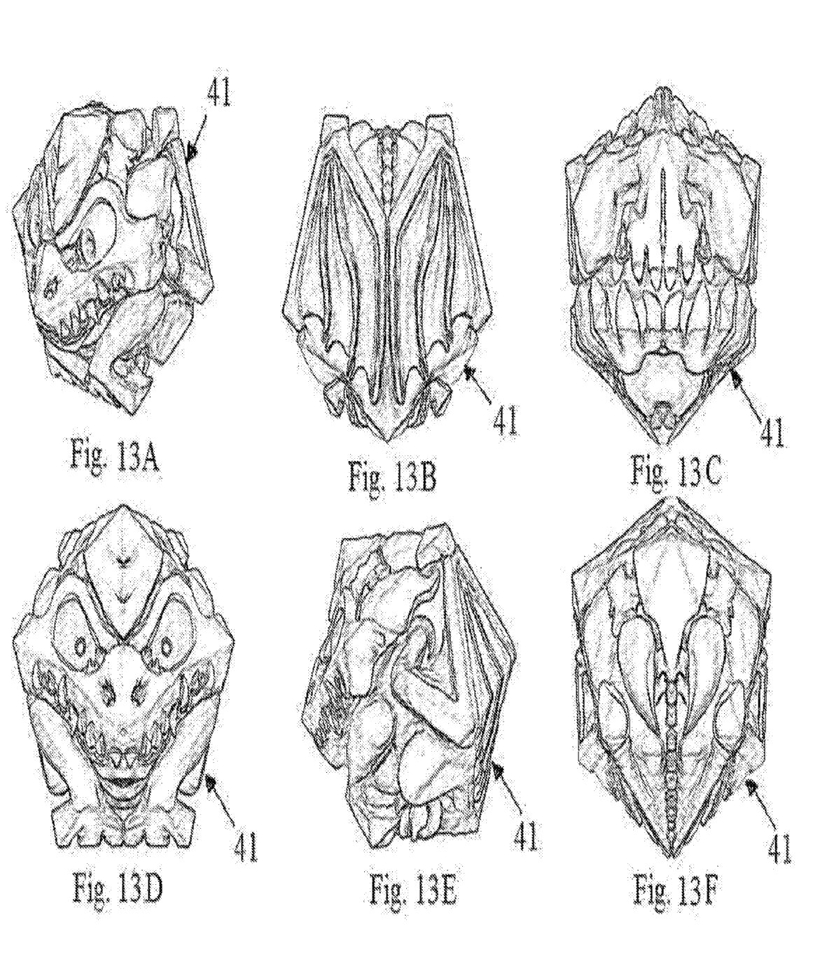

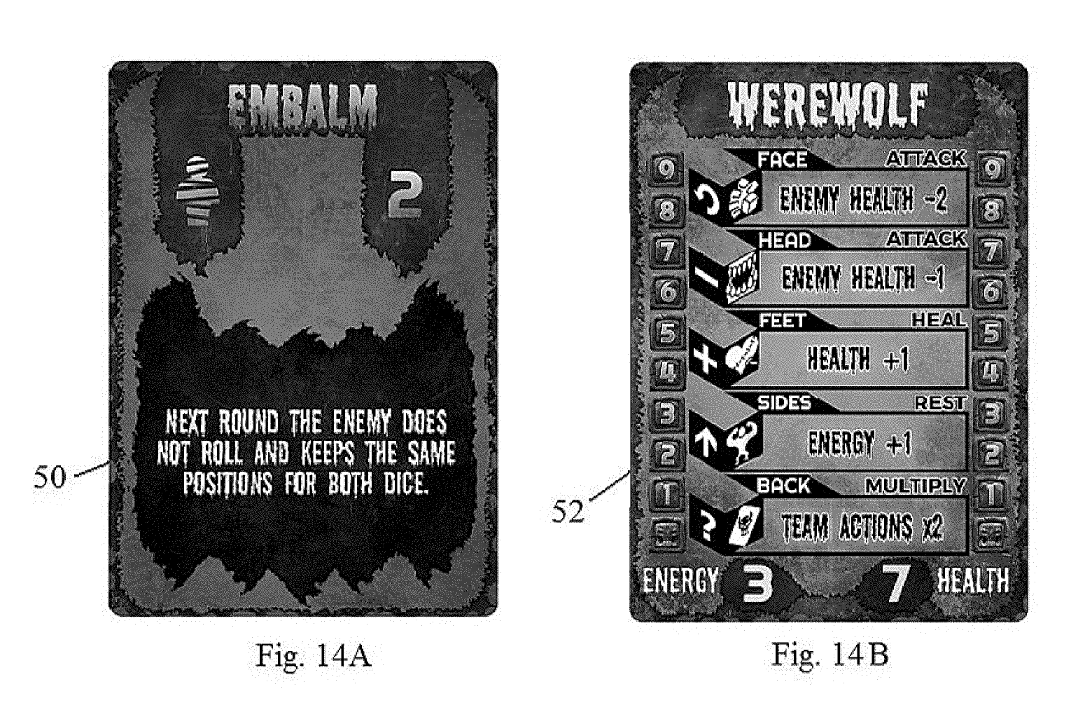

FIG. 11A shows the configuration of a block with ten equilateral sides. FIGS. 11B-D show a demon hunter generally at 38. FIGS. 12A-F depict a character configured as a Cerberus generally at 39 having 12 sides. FIGS. 13A-13F represent a 20-sided dragon generally at 41.

While the dies that have been described have been shown for use in a “real world” game, it will be appreciated the features of the present invention are equally adapted (perhaps, even better suited) for use in a “virtual world”, i.e, an electronic video game. It is intended that “character” include the concept of vehicles, buildings, as well as 3-D persona, real or imaginary. With the features available with 3-D printing, a character die configured as a dragon, for example, could have wings that fold out/upward when displayed on a shelf but snap into a non-extended position when the die is used in the game.

Details of games associated with any of the 6-sided dice follow.
SUGAR RUSH will test your reflexes, visual recognition, and fine motor skills.
Objective: The player who is the first to 4 (for example) Candy Cards wins the game.
1. Place one Candy Card in the middle of the table.
2. Players each get 4 Monster Dice and, on a rotating basis, one player says “On your mark, get set, roll!”; and players roll simultaneously.
3. Each player rolls their 4 Monster Dice; if any land FACE UP, the player places those Monster Dice on the Candy Card.
4. Each player continues to roll the remaining Monster Dice as rapidly as possible.
5. The first to roll and place 4 Monster Dice FACE UP on the Candy Card, takes the Candy Card.
6. Place another Candy Card in the middle of the table and continue until one player collects 4 Candy Cards.
CANDY GRAB is a press your luck game where you can win big or lose it all when you “GO FOR MORE”.
Objective: The player with the most Candy Cards wins the game.
1. Place the deck of Candy Cards on the table.
2. Players take turns rolling 4 Monster Dice, look to see if any Monster Dice landed FACE UP.
3. Choose to “GO FOR MORE” and roll 4 Monster Dice to add to your total OR take that number of Candy Cards and pass to the next player.
4 . If you choose to “GO FOR MORE” you must roll at least one FACE UP monster or you “BUST” and don't collect any Candy Cards this round.
5. Pass the Monster Dice to the next player. Repeat until all Candy Cards are gone.
6. The player with the most Candy Cards wins.

Various changes, alternatives, and modifications will become apparent to a person of ordinary skill in the art after a reading of the foregoing specification. For example, it will be appreciated that the Candy Card deck can be replaced by any deck of cards. Further, while these two games have been disclosed as involving rolling 4 three-dimensional character dice, it will be appreciated that any number from 2-6, or possibly even more, dice can be used without departing from the scope of the invention. It is intended that all such changes, alternatives, and modifications as fall within the scope of the appended claims be considered part of the present invention.

I claim:

1. A game played with a plurality of three-dimensional character dice and a deck of cards comprising the steps of:
a) place one card from the deck of cards in the middle of the table;
b) upon one player saying “On your mark, get set, roll!”; all players roll all of their three-dimensional character dice simultaneously;
c) each player moves each of the three-dimensional character dice which has landed face up to a position atop the one card in the middle of the table;
d) each player rolls the remaining three-dimensional character dice as rapidly as possible, as often as necessary, to obtain all their plurality of three-dimensional character dice in a face up position;
e) the first player to roll and place all their three-dimensional character dice face up on the card, wins the card;
f) repeat steps a)-e) until a player obtains a pre-agreed upon requisite number of cards;
g) declare this player the winner.

2. The game of claim 1 wherein the requisite number of cards is preferably 4

3. A game played with a plurality of three-dimensional character dice and a deck of cards comprising the steps of:
a) place the deck of cards in a center of a table where the game is to be played;
b) each player sequentially rolls their plurality of three-dimensional character dice attempting to have each one of them land face up;
c) during their turn, each player may opt to
i) take from the deck of cards, a number of cards equal to a number of three-dimensional character dice which landed face up; or,
ii) “Go for more” by re-rolling all dice trying to obtain a greater number of face up dice;
d) each player repeatedly opts in accordance with those selections set forth in c) until they opt in accordance with c) i or fail to have any of their three-dimensional character dice land face up at which point they “Bust” and their turn is over;
e) play continues until all cards in the deck have been won;
f) a count is taken and the player having won the most cards is declared “winner”.

5. A three-dimensional character die wherein said character die is made by a process including the steps of
a) forming a model using 3D printing;
b) creating a fillable mold using said model;
c) filling said fillable mold with a material to form said character die, said material being selected from a group consisting of thermoset resins and thermoplastic resins.
